(19) United States
(12) Patent Application Publication
(10) Pub. No.: US 2013/0074657 A1
(43) Pub. Date: Mar. 28, 2013

(54) WRENCH WITH EXPANDING TIP ASSEMBLY

(71) Applicant: John Robert Bishop, Harpers Ferry, WV (US)

(72) Inventor: John Robert Bishop, Harpers Ferry, WV (US)

(73) Assignees: and space Administration, Washington, DC (US); United States of America as represented by the Administration of the National Aeronautics

(21) Appl. No.: 13/240,180

(22) Filed: Sep. 22, 2011

(51) Int. Cl. B25B 23/10; B25B 23/16

(52) U.S. Cl. 81/53.1

(57) ABSTRACT

A tool assembly for engaging a head of a fastener. The tool assembly includes an elongated hollow shaft member having a first end and a second end and an actuation rod member moveably disposed within the shaft member. The actuation rod member includes a first end corresponding with the first end of the shaft member and a second end corresponding with the second end of the shaft member and an expandable tip assembly. One end of the expandable tip assembly is movably coupled to the actuation rod. The other end of the expandable tip assembly includes a patterned face. A first contracted state of the expanded tip assembly allows the patterned face to mate with the head of the fastener, and a second expanded state of the expanded tip assembly allows the patterned face to securely engage the head of the fastener.

### GOVERNMENT INTEREST

The U.S. government has the right to make, use and/or sell the invention described herein without payment of compensation, including but not limited to payment of royalties.

### BACKGROUND

1. Field

The aspects of the present disclosure relate generally to the field of hand tools and more specifically to hand tools for installing and removing fasteners.

2. Description of Related Art

Installing or removing fasteners in remote hard to reach locations, or in circumstances when a dropped fastener could result in damage to delicate or sensitive hardware located deep within an instrument enclosure, can be problematic. When installing a fastener it may be difficult to get the fastener into the hole and engage its threads. Similarly, when removing a fastener it may be difficult to extract it after it has been unscrewed. There is also the danger of dropping the fastener while transporting it to or from the hole. Assembly and mounting fasteners used in space instruments and military equipment are often located in difficult to reach areas. For example, the Sample Analysis at Mars Suite is an instrument about the size of a typical household microwave oven. It is fastened to the Mars Science Lab rover by fourteen 5-millimeter (mm) socket head cap screws. The washers for these fasteners are captive, but the fasteners are not. For attachment to thermal or vibration plates for various testing, access to these fasteners is relatively good, as this work can be accomplished without the side close-out panels in place. However, when the side panels are installed, as they will be for flight installations into the Mars Science Lab rover, access to the fastener locations will be through holes in a mid-plate. Due to the evolution of the design and build process, these holes are approximately 0.300 inch in diameter. The original design was to have the fasteners be captive, with access needed only for a driver to tighten and loosen them. However, the mid-plate had already been manufactured when the design was changed to use loose screws instead of captive screws. To accommodate this change, a “straw” device was created that could be inserted through the holes and past the maze of wiring harnesses and pipes to maintain control of the fasteners while they were being inserted or removed. The fasteners would then be fixed in place using a modified (extended) WIHA “MagicRing” hex wrench, which is the subject of U.S. Pat. No. 6,302,001.

The “MagicRing” hex wrench has a limited life cycle before the spring clip no longer retains the fastener. One option to address this deficiency is to make quite a few extension tools, perhaps one per fastener, to limit the amount of fatigue on the retaining spring. However, this presents cost and logistics problems.

Also, in many sensitive instruments, such as the Sample Analysis Mars Suite described above, it may not be possible to recover a fastener that has been dropped during insertion or removal. A dropped fastener can result in expensive and time consuming dis-assembly and re-work.

An additional problem occurred during a test installation of the Sample Analysis Mars Suite into the Mars Science Lab at the Jet Propulsion Laboratory. The head of each fastener is 0.285 inch diameter, while the hole in the mid-plate is 0.300 inch diameter. The difference between the dimension of the head of the fastener and the hole in the mid-plate leaves little room for the straw device. During installation, the fastener would go through the straw and the straw would go through the hole in the mid-plate. However, once the straw was inserted into the hole, the fastener would not pass the point where the straw passed through the mid-plate. As a result, design of the straw is a very thin and fragile device. The use of more robust straws or using a drill to enlarge the holes in the mid-plate creates other potential problems. These include contamination of the suite with debris generated from the drilling operation and the creation of burrs that may not be completely removable due to limited access. Also, access for the center fastener passes through notches in diagonal framing between the mid-plate and top frame. These notches are buried deep within the suite and cannot be enlarged due to limited access. A further problem is that drilling will remove gold plating on the inside diameter of the holes, thus creating the potential of causing a de-lamination condition of the gold plating that could propagate during operation of the Sample Analysis Mars Suite.

Accordingly, it would be desirable to provide an apparatus or device that addresses at least some of the problems identified above.

### SUMMARY OF THE INVENTION

As described herein, the exemplary embodiments overcome one or more of the above or other disadvantages known in the art.

One aspect of the exemplary embodiments relates a tool assembly for engaging a head of a fastener. The tool assembly including an elongated hollow shaft member having a first end and a second end. The actuation rod member is moveably disposed within the shaft member. The actuation rod member includes a first end corresponding with the first end of the shaft member and a second end corresponding with the second end of the shaft member and expandable tip assembly. One end of the expandable tip assembly is movably coupled to the actuation rod. The other end of the expanded tip assembly has a patterned face. In a first contracted state of the expandable tip assembly the patterned face is configured to mate with the head of a fastener, and in a second expanded state, the patterned face of the tip assembly is configured to securely engage the head of the fastener.

Another aspect of the exemplary embodiments relates to an expandable tip member for a tool assembly for engaging a head of a fastener. The expandable tip member includes a first end and a second end, the first end configured to be attached to the tool assembly, and the second end having a patterned face. The expandable tip member has a first contracted state in which the patterned face is configured to mate with the head of a fastener, and a second expanded state in which the patterned face is configured to securely engage the head of the fastener.

These and other aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

In the drawings:

FIG. 1 illustrates an exemplary expanding tip wrench assembly incorporating aspects of the present disclosure.

FIG. 2 illustrates an exemplary body portion of an expanding tip wrench assembly incorporating aspects of the present disclosure.

FIG. 3 illustrates an exemplary actuator portion of an expanding tip wrench assembly incorporating aspects of the present disclosure.

FIG. 4 illustrates an exemplary expanding tip assembly incorporating aspects of the present disclosure.

FIG. 5 illustrates a side view of the exemplary expanding tip assembly incorporating aspects of the present disclosure.

FIG. 6 illustrates a sectional view of the exemplary expanding tip assembly incorporating aspects of the present disclosure.

FIG. 7 illustrates a detail view of the actuating section of an exemplary expanding tip assembly incorporating aspects of the present disclosure.

FIG. 8 illustrates an end view of the exemplary expanding tip assembly incorporating aspects of the present disclosure.

FIG. 9 illustrates an exemplary tip assembly incorporating aspects of the present disclosure for a square socket head fastener.

FIG. 10 illustrates an exemplary tip assembly incorporating aspects of the present disclosure for a spanner type socket head fastener.

### DETAILED DESCRIPTION OF THE EXEMPLARY EMBODIMENTS OF THE DISCLOSURE

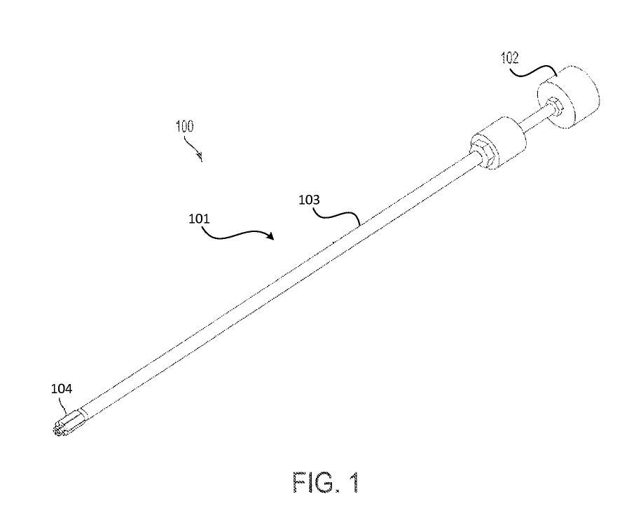

Referring to FIG. 1, aspects of the disclosed embodiments are directed to a tool assembly for engaging a head of a fastener, such as socket head cap screws. For the purposes of the description herein, the fasteners will be referred to as socket head cap screws. In alternate embodiments, the fasteners can include any suitable fastener.

The tool assembly 100, also referred to herein as an expanding tip wrench assembly, securely mates to and engages to the head or socket of a socket head cap screw. This engagement allows the screw to be easily and reliably positioned at the screw hole, even when the screw hole is in a limited access area. Once the screw is suitably positioned, the screw can be installed or the threads of the screw and screw hole engaged. Alternatively, in a screw removal process, the screw can be disengaged from the screw hole with the screw securely engaged with the tool assembly 100, which significantly reducing the possibility of the screw being dropped.

FIG. 1 illustrates an exemplary embodiment of an expanding tip wrench assembly 100 incorporating aspects of the present disclosure. As is shown in FIG. 1, the expanding tip wrench 100 includes a tool body 101 and an actuating knob portion 102. The tool body 101 includes a shaft portion 103 and a tip assembly 104. The knob portion 102 is used to control the expansion and contraction of the tip 104 for engaging a fastener such as a socket head cap screw. In operation of one embodiment of the expanding tip wrench assembly 100, the knob 102 is rotated, such as for example in a counterclockwise direction with respect to the tool body 101 until the tip 104 has contracted to its smallest position. The tip assembly 104 is then inserted into the head or socket of the socket head cap screw. While maintaining the tip assembly 104 inserted in the socket, the knob 102 is rotated in the opposite direction, such as clockwise, with respect to the tool body 101. This rotation expands the tip assembly 104 securing the socket head cap screw on the tip assembly 104 of the expanding tip wrench assembly 100. The expanding tip wrench assembly 100, with the screw affixed to the tip assembly 104, can be positioned to engage or disengage the screw with the desired screw hole. During an installation, once the socket head cap screw is in suitably engaged in the screw hole, the knob 102 is rotated counterclockwise to contract the tip assembly 104 thereby releasing the socket head cap screw from the tip assembly 104. The expanding tip wrench assembly 100 can then be removed and the socket head cap screw may be tightened and torqued using conventional tools. The expanding tip wrench assembly 100 is generally configured as a holding and starting tool and provides for engaging a fastener in a corresponding fastener opening that is not easily or readily accessible, or where a dropped screw could result in damage to delicate or sensitive hardware located deep within instrument housings.

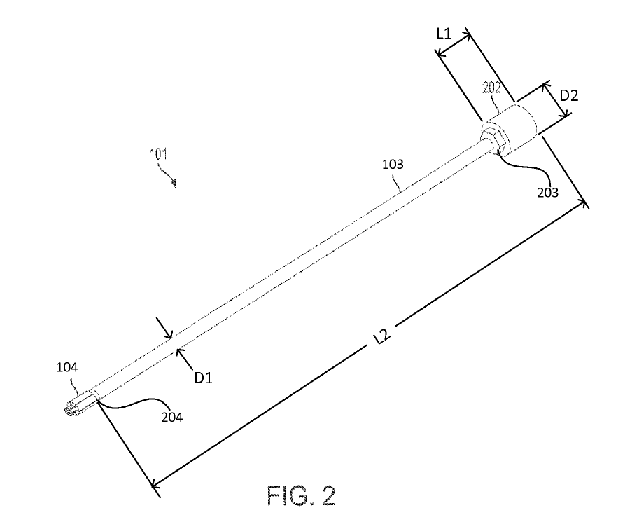

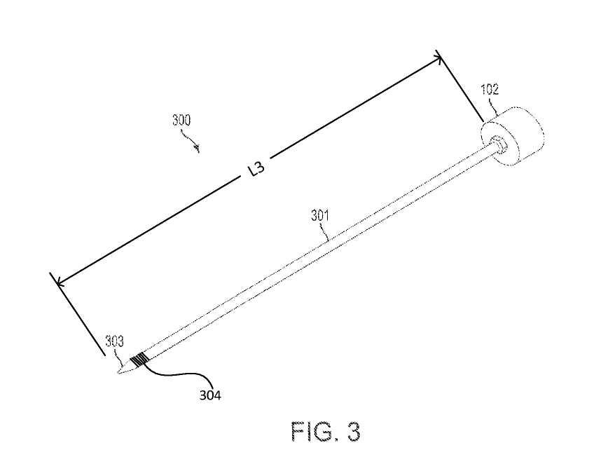

Referring to FIG. 2 and FIG. 3, in one embodiment the expanding tip wrench assembly 100 is comprised of two assemblies. FIG. 2 illustrates an exemplary embodiment of a tool body 101 and FIG. 3 illustrates an exemplary embodiment of an actuator 300 located within the tool body 101 that is used to expand and contract the expanding tip assembly 104 shown in FIG. 2. As shown in FIG. 2, the tool body 101 is comprised of a tubular or hollow shaft 103, an expanding tip assembly 104 and a handle or knob 202. In one embodiment, the hollow shaft 103 is constructed of a material such as steel or aluminum. The shaft 103 can have a length L2 that provides the user with adequate reach to engage the tip assembly 104 with the head of the socket head cap screw and position the screw in the location of interest. The outside diameter D1 of the shaft 103 is generally sized to allow easy access to the location where the socket head cap screw is being installed while being large enough to maintain structural integrity of the shaft 103 and enclosed actuator 300 shown in FIG. 3. For example, as described above, the access holes in the Sample Analysis Mars Suite are approximately 0.300 inches in diameter. Making the outside diameter D1 of the shaft 103 approximately 0.250 inches allows the wrench assembly 100 to pass through the access hole while providing enough structural strength to impart adequate holding force on the socket head cap screw. At the lower end of the shaft 103 is the expanding tip assembly 104 which will be described in further detail below. At the upper end of the shaft 103 is a handle or knob 202 with a hole (not shown) bored through its central axis such that the shaft 103 can be inserted into the hole. In one embodiment, the handle or knob 202 is used to hold the tool body 101 in place while the knob 102 is used to expand or contract the expanding tip assembly 104. In the embodiment shown in FIG. 2 the handle or knob 202 is generally cylindrical in shape with a diameter D2 that is smaller than its length L1. For example, in the exemplary embodiment shown in FIG. 2, the diameter D2 of the knob is approximately 1 inch and the length L is approximately 1.25 inches. However, a cylindrical knob D1 with a diameter larger than its length L1 can also be used if desired, or alternatively other shapes, such as round balls etc., can be used for the handle or knob 202. The knob 202 is affixed to the upper end of the shaft 103 using a press fit, weld, or other suitable means of creating a secure connection. Alternatively, the knob 202 may be semi-permanently attached to the shaft 103 by threading the outer surface of the end of the shaft 103 and the inner surface of the through hole in the knob 202 and screwing the knob 202 onto the upper end of the shaft 103. With this threaded arrangement, a stop nut 203 may be used to secure the threaded knob 202 on the upper end of the threaded shaft 103 and prevent it from rotating while the tool assembly 100 is in use. A semi-permanent attachment, such as the threaded arrangement just described, is one that securely holds the knob 202 to the shaft 103 during use of the expanding tip wrench assembly 100 but allows the knob 202 to be removed for maintenance or repair of the expanding tip wrench 100.

Referring to FIG. 3, one embodiment of the actuator assembly 300 is illustrated. The actuator assembly 300 is used to expand and contract the expanding tip assembly 104 of the wrench 100. An exemplary embodiment of the actuator 300 comprises an actuating rod 301 coupled to the knob 102. In one embodiment, one end 303 of the actuating rod 301 is tapered. The actuating rod 301 can be made of steel or other suitable materials. In the exemplary embodiment shown in FIG. 3, the actuating rod 301 has a length L3 that is longer than the length L2 of shaft 103. In this embodiment, the knob 102 is at one end of the rod 301 and the tapered end 303 extends from the other manner and is configured to engage the tip assembly 104 as will be described below. In the exemplary embodiment shown in FIG. 3 the actuating rod 301 is constructed from a length of all-thread material or rod. “All-thread” generally refers to a metal rod that is threaded along its entire length. However, as will be described below, it is not necessary to thread the entire length of the actuating rod 301, and in some embodiments the actuating rod 301 may not contain any threads at all.

As is shown in FIG. 3, the knob 102 is coupled to the upper end of the actuating rod 301. The knob 102 may be permanently or semi-permanently attached to the rod 301 using any of the methods discussed above with respect to the attachment of the knob 202 to the shaft 103. Also, as was discussed above regarding the knob 202, alternative embodiments of the knob 102 can use shapes other than the cylindrical shape shown in FIG. 1 and FIG. 3. The lower end 303 of the actuating rod 301 includes a tapered section 303 that is configured to engage an actuator portion of the expanding tip assembly 104. A section of the lower end of actuating rod 301, located above the tapered section 303, includes threads 304 to engage threads on the inside of the expanding tip assembly 104. When engaged, these threads 304 will pull the actuating rod 301 into the expanding tip assembly 104 when the knob 102 is rotated forcing the tapered end 303 farther into the expanding tip assembly 104 thereby expanding the tip assembly 104 as is further described below.

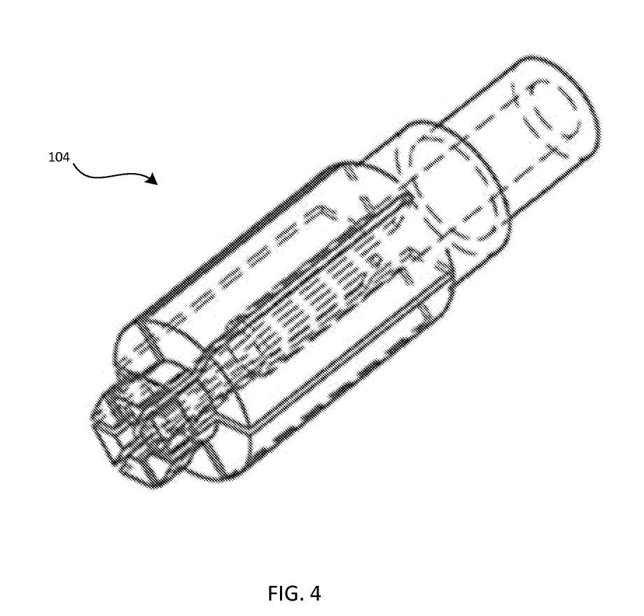

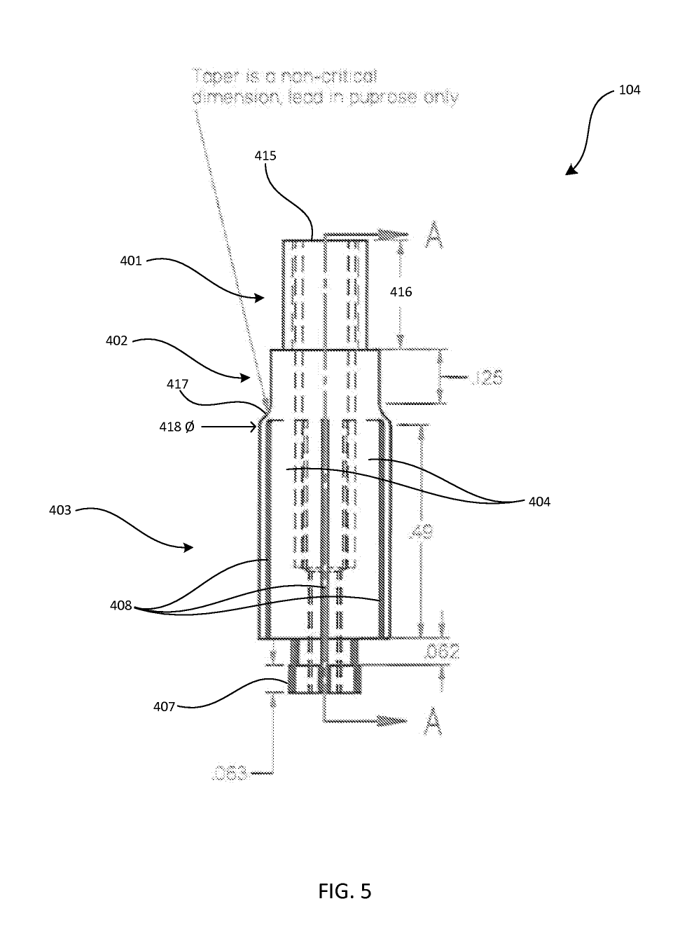

FIG. 4 illustrates a perspective view of an exemplary embodiment of an expanding tip assembly 104. In this example, the expanding tip assembly 104 is configured for use with socket head cap screws that have a hex socket, i.e. a six sided socket. Hex socket cap screws, often referred to as Allen screws, are one of the more common types of socket head cap screws currently being used. FIGS. 5-8 illustrate several different views of the hex type expanding tip assembly 104 shown in FIG. 4. Those skilled in the art will recognize that the expanding tip assembly 104 disclosed herein is not limited to hex socket type fasteners and that the expanding tip assembly 104 can be readily adapted for use with many other types of socket head cap screws, including, but not limited to, Robertson™, Torx™, Bristol™, Pentabular, type fasteners, without straying from the spirit and scope of the present disclosure. It will also be easily recognized that many multi-socket fasteners, such as the two-hole spanner head type fastener, can also be easily accommodated by the expanding tip assembly 104 disclosed herein.

FIG. 5 illustrates a side view of the expanding tip assembly 104 shown in FIG. 4. One end 415 of the expanding tip assembly 104, referred to herein as “top end” 415, is configured as an attachment portion 401 that allows the expanding tip assembly 104 to be coupled to the lower end 204 of the shaft 201. In one embodiment the attachment portion 401 is threaded on its outer surface, using for example #10-32 UNF threads, which allow for coupling to the shaft 201. In alternate embodiments the attachment of the attachment portion 401 to the lower end 204 of the shaft 103 can be made using any suitable permanent or semi-permanent attachment mechanism, such as those discussed above. In the exemplary embodiment shown in FIG. 5, the attachment portion 401 has a length 416 that is approximately 0.250″ long. In alternate embodiments, the length 416 may be any length that allows it to be reliably and securely attached to the shaft 103. Below the attachment portion 401 is a lead-in portion 402. The lead-in portion 402 is configured to form a smooth transition between the outside of the shaft 201 and the outside of the expanding tip assembly 104 in order eliminate any sharp edges that could get caught on obstructions, such as access holes, wires, and the like, that the expanding tip wrench assembly 100 may have to slide through or past while transporting the socket head cap screw to or from its desired location. In the exemplary embodiment shown in FIG. 5, a substantially smooth transition is achieved with a taper 417. In the embodiment of FIG. 5, the expanding tip assembly 104 has a diameter 418 of approximately 0.300 inches which is larger than the diameter D1 of shaft 201 which is approximately 0.25 inches. The lead-in portion 402 comprises a substantially smooth taper 417 from the smaller shaft diameter D1 to the larger diameter 418 of the expanding tip assembly 103. In alternate embodiments, the diameter D1 of the shaft 202 may be larger than the diameter 418 of the expanding tip assembly 104 and either or both may have cross sectional shapes or patterns that are not round, such as for example square, hexagon, etc. In any of these alternate embodiments the lead-in portion 402 is shaped to provide a substantially smooth transition between the legs 404 and the shaft 201 so that there are no edges or surfaces that can catch on obstructions while the expanding tip wrench assembly 100 is being moved in the desired area.

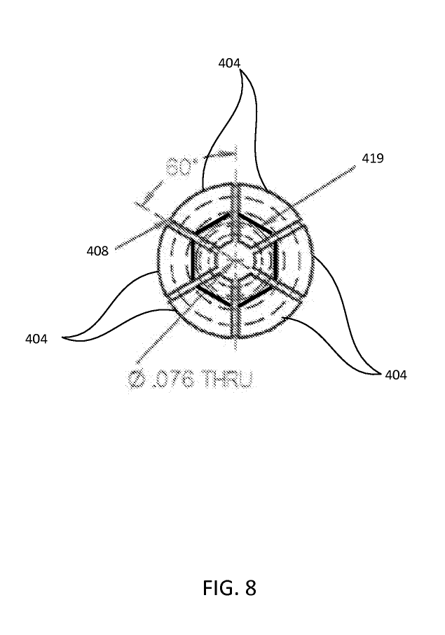

Referring to FIG. 5, below the lead-in portion 402 of the expanding tip assembly 104 is an expanding portion 403. The expanding portion 403 comprises a set of leg members 404. The leg members 404 are configured to be forced out away from the center axis of the expanding tip 104 to engage and grip the internal pattern of the head of the fastener. In the embodiment shown in FIG. 4, which is designed for a hex socket fastener, there are six expanding leg members 404. The six expanding leg members 404 can be seen in FIG. 8 which provides an end view of the expanding tip assembly 104 looking at the gripping end 407 of the expanding tip assembly 104 along the major axis. The gripping end 407 forms a pattern that corresponds to the pattern of the head of the socket and is configured to engage the patterned area in the head of the socket. These leg members 404 are formed by creating slits 408 running lengthwise up the expanding portion 403 from the gripping end 407 to the transition portion 403 as shown in FIG. 5. In the exemplary embodiment of an expanding tip assembly 104 illustrated in FIGS. 4-6, the expanding tip 104 is milled from a single piece of material. Alternatively, each leg member 404 of the expanding tip 104 can be formed separately, and then attached to the shaft 103 in a suitable manner.

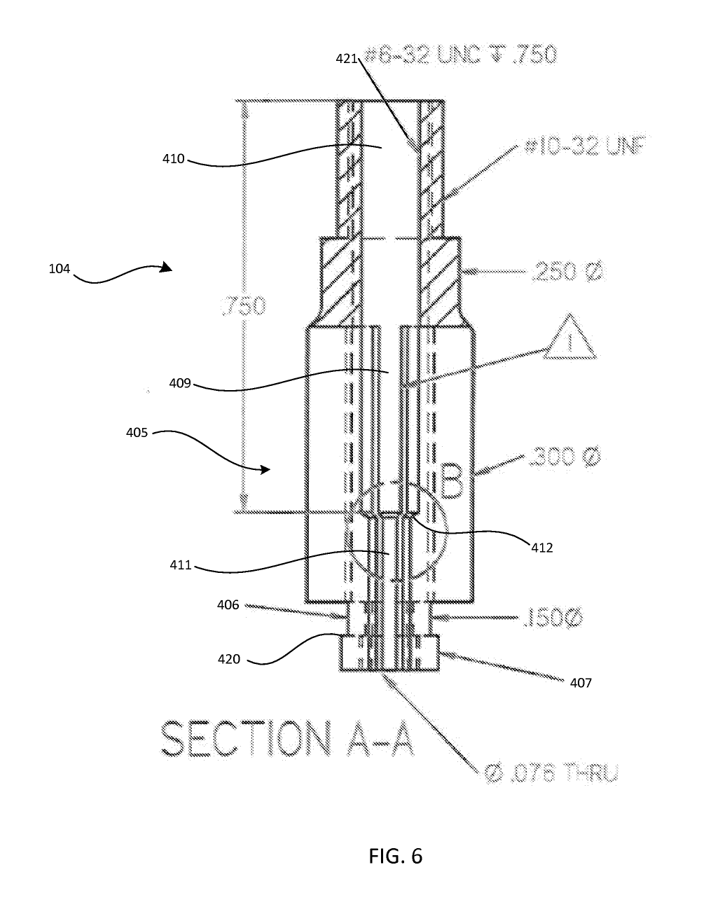

FIG. 6 illustrates a sectional view A-A of the expanding tip assembly 104 shown in FIG. 5. The expanding portion 403 has three sections: an actuating section 405, a clearance section 406, and a gripping section 407. The gripping section 407 is inserted into the socket of the socket head cap screw and, when the tip 104 is expanded, the gripping section 407 securely engages or “grips” the inner surfaces of the fastener's socket to hold the fastener on the expanding tip wrench assembly 100. In the exemplary embodiment shown in FIG. 4 the cross sectional shape or pattern 419, as shown in FIG. 8 of the gripping section 407, has substantially the same hex shape as the socket of the socket head cap screw to allow the gripping section to engage the head of the socket.

In the exemplary embodiment shown in FIG. 4, a clearance section 406 is disposed between the gripping section 407 and the expanding section 405. The clearance section 406 is generally configured to ease manufacture and/or to improve gripping force. In alternate embodiments, the clearance section 406 is not always necessary. By including a clearance section 406, the relatively sharp upper edge 420 of the gripping section 407 contacts the inner surface of the socket of the socket head cap screw. Having this sharp edge 420 in contact with the socket of the socket head cap screw can in some instances, increase the force necessary to pull the screw off the end of the expanding tip wrench assembly 100. Tests of the exemplary embodiment of the expanding tip assembly 104 shown in FIG. 4 indicate that as much as 8 pounds of force is necessary to pull a hex socket head cap screw off the expanding tip wrench assembly 100 while the gripping section 407 was in the expanded position.

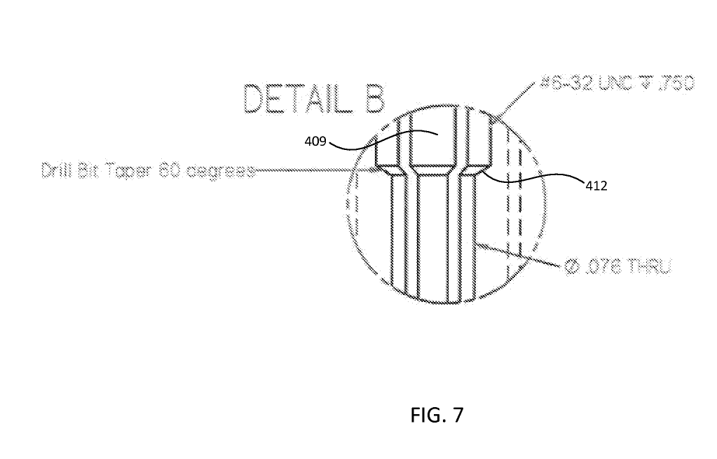

The actuating section 405 of the expanding portion 403 is generally configured to provide length to the leg members 404 allowing them to flex as the gripping section 407 is expanded. The inner surfaces of the leg members 404 of the actuating section 405 are configured to allow the tapered end 303 of the actuator assembly 300 to push the leg members 404 apart, or away from the central axis of the actuator rod 301 and shaft 103. A tapered hole 409 is fashioned along the center axis of the entire expanding tip assembly 104 such that the top part 410 of the tapered hole 409 is larger than the bottom part 411 of the tapered hole 409. FIG. 7 illustrates a detail view of an exemplary embodiment of the tapered part 412 of tapered hole 409. The inside surface 421 of the hole 409 in the attachment portion 401 is sized to receive the actuating rod 301 and is threaded, with for example #6-32 UNC threads, to engage threads 304 on the actuating rod 301. The hole 409 is tapered within the actuating portion 405, as shown by 412 in FIG. 7, such that the tapered end 303 of the actuating rod 301 contacts the tapered surface 412 of each of the leg members 404. When the actuating rod 301 is screwed farther into the expanding tip 104, the tapered end 303 of the actuating rod 301 is pushed farther into the tapered hole 409, thereby forcing the leg members 404 apart and causing the gripping portion 407 to expand.

In the exemplary embodiment shown in FIG. 4, the threads 304 on the outer circumference of the actuating rod 301 and on the inner circumference of the expanding tip 409 are used to hold the leg members 404 in an actuated, i.e. expanded, position. In alternate embodiments, there are no threads in the expanding tip 104 or the actuating rod 301. Rather, the expanding tip 104 and actuating rod 301 have substantially smooth surfaces that allow the leg members 404 of the expanding tip 104 to be expanded by pushing the actuating rod 301 farther into the expanding tip 104, and allow the leg members 404 of the expanding tip 104 to be contracted by pulling the actuating rod 301 farther out of the expanding tip assembly 104.

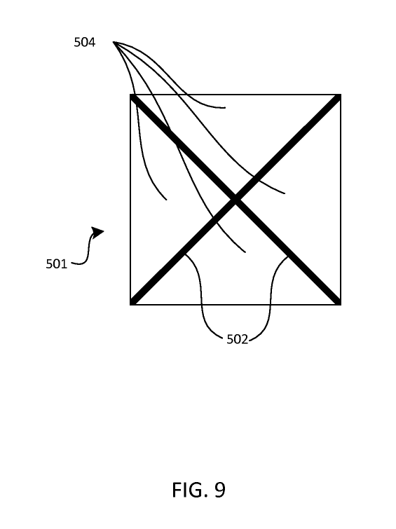

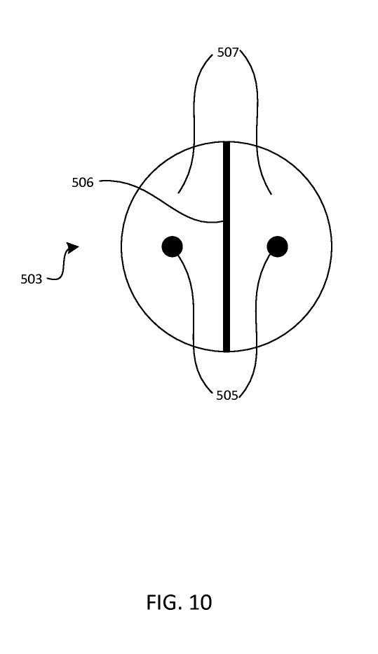

The cross sectional shape or formed pattern, and number of leg members 404 of the expanding tip assembly 104, is determined by the type of pattern in the head of the fastener for which the tip assembly 104 is to be used. Although the expanding tip assembly 104 shown in FIG. 4 is described as designed for a hex socket, the expanding tip 104 disclosed herein can easily be adapted for other socket types by adjusting the cross sectional shape of, or pattern formed by the gripping portion 407 and the number of leg members 404. FIGS. 9 and 10 illustrate cross sectional views of exemplary embodiments of different expanding tips 501 and 503, adapted for square and spanner type socket head cap screws respectively. For example, to accommodate square sockets, the gripping portion 407 would be configured to form a pattern with a square cross sectional shape 501. Two slits 502 would be formed through the four points of the square 501 to create four legs 504. Referring to FIG. 10, a spanner type socket head cap screw can be accommodated using an expanding tip assembly 104 where the gripping section 407 forms a pattern having a substantially round cross sectional shape 503, similar to the pattern in the head of the spanner type socket head cap screw. In this example, the gripping section has two pins 505 configured to fit into the two corresponding holes in the spanner head of the socket head cap screw. A single slit 506 is formed between the two pins 505 creating two legs 507 in the expanding tip assembly 104. Those skilled in the art will recognize that the expanding tip assembly 104 of the present disclosure can be readily adapted for use with many types of fasteners and screws without straying from the spirit and scope of the present disclosure.

For the purposes of this disclosure the terms “top” and “bottom” are used for illustrative and descriptive purposes only. The relational terms “above”, “up”, and “upward” are used to generally refer to a direction or position farther away from an end that is illustratively designated as bottom portion, lower end, or second end. The terms “below”, “down”, and “downward” are used to generally refer to a direction or position farther away from an end that is illustratively designated as a top portion, upper end or first end.

The aspects of the disclosed embodiments provide a tool assembly for engaging the head of a fastener, such as socket head cap screw, that allows the fastener to be positioned in areas that are generally difficult to reach for installation and/or removal. The tool assembly, or expanding tip wrench, firmly engages the pattern in the head of the fastener in a fashion that allows the screw to be easily and reliably installed and the threads engaged, or for the threads to be disengaged and the screw reliably removed, while significantly reducing the possibility of a fastener being dropped. This is particularly advantageous when installing or removing fasteners in remote or hard to reach locations, or in circumstances when a dropped fastener could result in damage to delicate or sensitive hardware located deep within an instrument enclosure, or when a dropped fastener could only be retrieved by disassembly of the unit.

Thus, while there have been shown, described and pointed out, fundamental novel features of the invention as applied to the exemplary embodiments thereof, it will be understood that various omissions and substitutions and changes in the form and details of devices and methods illustrated, and in their operation, may be made by those skilled in the art without departing from the spirit or scope of the invention. Moreover, it is expressly intended that all combinations of those elements and/or method steps, which perform substantially the same function in substantially the same way to achieve the same results, are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A tool assembly for engaging a head of a fastener comprising:
an elongated hollow shaft member having a first end and a second end;
an actuation rod member moveably disposed within the shaft member, the actuation rod member comprising a first end corresponding with the first end of the shaft member and a second end corresponding with the second end of the shaft member; and
an expandable tip assembly, one end of the expandable tip assembly movably coupled to the actuation rod, an other end of the expandable tip assembly having a patterned face, the expandable tip having a first contracted state, wherein the patterned face is configured to mate with the head of the fastener, and a second expanded state, wherein the patterned face is configured to securely engage the head of the fastener.

2. The tool assembly of claim 1, wherein the expandable tip assembly comprises two or more leg members extending longitudinally from the second end of the shaft, the leg members arranged symmetrically around the second end of the actuation rod member, each leg member having a first end and a second end, wherein the first end of each leg member is attached to the second end of the shaft member, the second ends of the leg members form a patterned face that is configured to mate with the head of the fastener.

3. The tool assembly of claim 2, wherein a first movement of the actuation rod member moves the second end of each of the leg members away from a major axis of the shaft member and a second movement of the actuation rod member moves the second end of each of the leg members toward a major axis of the shaft member.

4. The tool assembly of claim 2, wherein the leg members comprise six leg members, and the patterned face formed by the second ends of the leg members is a hexagon.

5. The tool assembly of claim 2, wherein the second end of the actuation rod member comprises a tapered portion, and a threaded portion disposed above the tapered portion;
the shaft member comprises an inner threaded portion; and
the threaded portion of the actuation rod member is configured to engage the threaded portion of the shaft member such that a rotation of the actuation rod member within the shaft member in a first direction moves the second end of each of the two or more leg members away from a major axis of the shaft member and a rotation of the actuation rod member in a second direction moves the second end of each of the leg members toward a major axis of the shaft member.

6. The tool assembly of claim 2, wherein an inner surface of each of the two or more leg members comprises a taper in operable communication with the tapered portion of the actuation rod member, the taper being configured such that a first longitudinal movement of the actuation rod member moves the second end of each of the two or more leg members away from a major axis of the shaft member and a second longitudinal movement of the actuation rod member moves the second end of each of the leg members toward a major axis of the shaft member.

7. The tool assembly of claim 1, further comprising a first knob attached to the first end of the shaft member and a second knob attached to the first end of the actuation rod member.

8. The tool assembly of claim 1, wherein the two or more leg members comprise a cross section above the second ends of the two or more leg members, the cross section configured to provide a smooth transition between the head of the fastener and the two or more leg members.

9. The tool assembly of claim 8, wherein the shaft member comprises a transition portion, disposed above the second end of the shaft member, the transition portion configured to provide a smooth transition between an outer surface of each of the two or more leg members and the shaft member.

10. An expandable tip member for a tool assembly for engaging a head of a fastener, the expandable tip member comprising a first end and a second end,
the first end configured to be attached to the tool assembly, and the second end having a patterned face,
the expandable tip member having a first contracted state, wherein the patterned face is configured to mate with the head of the fastener, and a second expanded state, wherein the patterned face is configured to securely engage the head of the fastener.

11. The expandable tip member of claim 10, wherein the expandable tip further comprises:
a transition portion disposed below the first end; and
a plurality of leg members extending longitudinally from the transition portion, the plurality of leg members arranged symmetrically around a major axis of the expandable tip member, each leg member having a first end and a second end, wherein the first end of each leg member is attached to the transition portion, and the second ends of the leg members form a patterned face that is configured to mate with the head of the fastener.

12. The expandable tip member of claim 11 wherein the transition portion is configured to provide a smooth transition from the tool assembly to the plurality of leg members.

13. The expandable tip member of claim 11, wherein the plurality of leg members comprise six leg members, and the patterned face is a hexagon.

14. The expandable tip member of claim 11, wherein the plurality of leg members comprise a cross section above the second ends of the leg members, the cross section configured to provide a smooth transition between the head of the fastener and the plurality of leg members.

15. The expandable tip member of claim 11, further comprising an actuation rod member having a first end corresponding to the first end of the expandable tip member and a second end disposed within the plurality of leg members,
the second end of the actuation rod member comprising a tapered portion;
wherein a first movement of the actuation rod member within the expandable tip member moves the second end of each of the plurality of leg members away from a major axis of the expandable tip member and a second movement of the actuation rod member within the expandable tip member moves the second end of each of the plurality of leg members toward the major axis of the expandable tip member.

16. The expandable tip member of claim 15, wherein the actuation rod member further comprises a threaded portion disposed above the tapered portion, and
the transition portion comprises an inner threaded portion,
wherein the threaded portion of the actuation rod member is configured to engage the inner threaded portion of the transition portion such that a first rotational movement of the actuation rod member within the transition portion moves the second end of each of the plurality of leg members away from a major axis of the expandable tip member and a second rotational movement of the actuation rod member within the transition portion moves the second end of each of the plurality of leg members toward the major axis of the expandable tip member.

17. The expandable tip member of claim 15 wherein an inner surface of each of the plurality of leg member comprises a taper in operable communication with the tapered portion of the actuation rod member, and configured such that a first longitudinal movement of the actuation rod member within the expandable tip member moves the second end of each of the plurality of leg members away from a major axis of the expandable tip member and a longitudinal movement of the actuation rod member within the transition portion moves the second end of each of the plurality of leg members toward the major axis of the expandable tip member.
